(19) United States
(12) Patent Application Publication
(10) Pub. No.: US 2025/0120540 A1
(43) Pub. Date: Apr. 17, 2025

(54) FOOD WARMING AND STORAGE ASSEMBLY

(71) Applicant: Donte Marshall, Chicago, IL (US)

(72) Inventor: Donte Marshall, Chicago, IL (US)

(21) Appl. No.: 18/381,086

(22) Filed: Oct. 17, 2023

(51) Int. Cl. A47J 36/24; B65D 81/34

(52) U.S. Cl. CPC A47J 36/2483; B65D 81/3484

(57) ABSTRACT

A food warming and storage assembly includes a bowl to store a liquid food. A bowl heating unit is integrated into the bowl to heat the liquid food when the liquid food is stored in the bowl. A solid food tub is provided to contain a solid food. A solid food lid is removably attachable to the solid food tub and a solid food heating unit is integrated into the solid food lid to heat the solid food contained in the solid food tub. A container tub is provided to contain a food product. A container lid is removably attachable to the container tub and a container lid heating unit is integrated into the container lid to heat the food product in the container tub. A container tub heating unit is integrated into the container tub to heat food containers when the food containers are stored in the container tub.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to food warming devices and more particularly pertains to a new food warming device for storing and warming a variety of food products. The device includes a bowl and a bowl heating unit integrated into the bowl for heating a liquid food stored in the bowl. The device includes a solid food container for containing a solid food and a solid food heating unit integrated into a solid food lid which is positionable on the solid food container for warming the solid food in the solid food container. The device includes a container tub and a plurality of food containers that are positionable in the container tub and a container tub heating unit integrated into the container tub for warming the food containers. The device includes a container lid and a container lid heating unit integrated into the container lid to warm the food containers.

### (2) Description of Related Art Including Information Disclosed Under 37 CFR 1.97 and 1.98

The prior art relates to food warming devices including a variety of food warming devices that each at least includes a container that is structured to contain a food product and a heating unit integrated into the container for warming the food product. In no instance does the prior art disclose a food warming device that includes a plurality of containers for storing respective types of food products and a plurality of heating units that are each integrated into a respective container for warming the food in the respective container.

### (h) BRIEF SUMMARY OF THE INVENTION

An embodiment of the disclosure meets the needs presented above by generally comprising a bowl to store a liquid food. A bowl heating unit is integrated into the bowl to heat the liquid food when the liquid food is stored in the bowl. A solid food tub is provided to contain a solid food. A solid food lid is removably attachable to the solid food tub and a solid food heating unit is integrated into the solid food lid to heat the solid food contained in the solid food tub. A container tub is provided to contain a food product. A container lid is removably attachable to the container tub and a container lid heating unit is integrated into the container lid to heat the food product in the container tub. A container tub heating unit is integrated into the container tub to heat food containers when the food containers are stored in the container tub.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective phantom view of a food warming and storage assembly according to an embodiment of the disclosure.

FIG. 2 is a top exploded perspective view of a solid food tub and a solid food lid of an embodiment of the disclosure.

FIG. 3 is a bottom exploded perspective view of a solid food tub and a solid food lid of an embodiment of the disclosure.

FIG. 4 is a left side phantom view of an embodiment of the disclosure.

FIG. 5 is a cross sectional view taken along line 5-5 of FIG. 4 of an embodiment of the disclosure.

FIG. 6 is a top exploded perspective view of bowl and a bowl lid of an embodiment of the disclosure.

FIG. 7 is a bottom exploded perspective view of a bowl and a bowl lid of an embodiment of the disclosure.

FIG. 8 is a front view of a bowl and a bowl lid of an embodiment of the disclosure.

FIG. 9 is a cross sectional view taken along line 9-9 of FIG. 8 of an embodiment of the disclosure.

FIG. 10 is an exploded perspective view of an embodiment of the disclosure.

FIG. 11 is a front view of a container tub of an embodiment of the disclosure.

FIG. 12 is a cross sectional view taken along line 12-12 of FIG. 11 of an embodiment of the disclosure.

FIG. 13 is a cross sectional view taken along line 13-13 of FIG. 11 of an embodiment of the disclosure.

FIG. 14 is a schematic view of an embodiment of the disclosure.

FIG. 15 is a schematic view of an embodiment of the disclosure.

### (j) DETAILED DESCRIPTION OF THE INVENTION

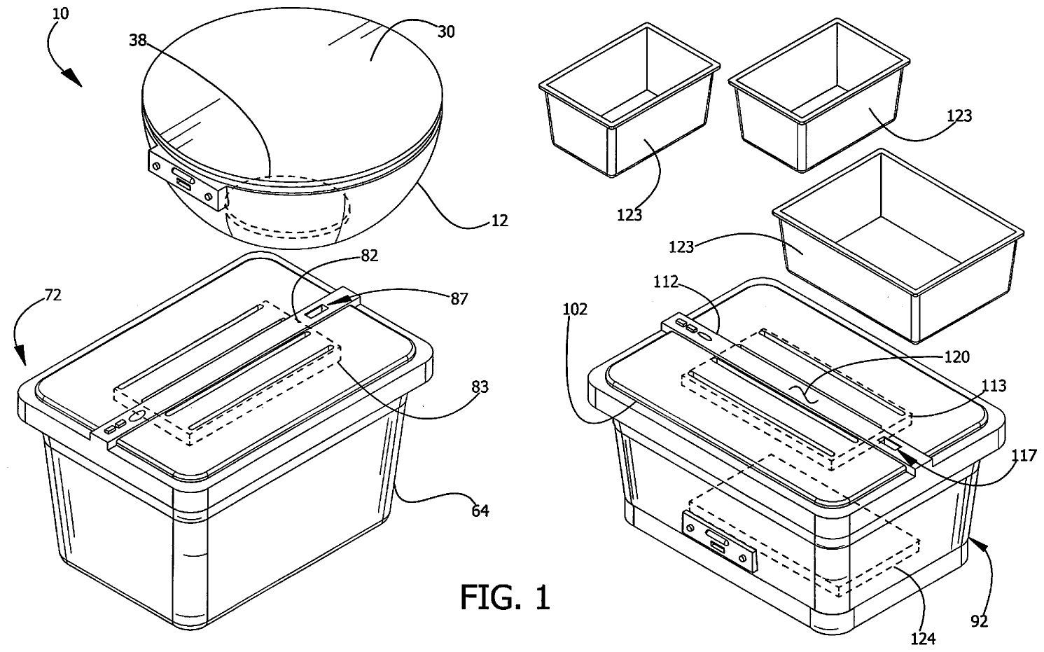

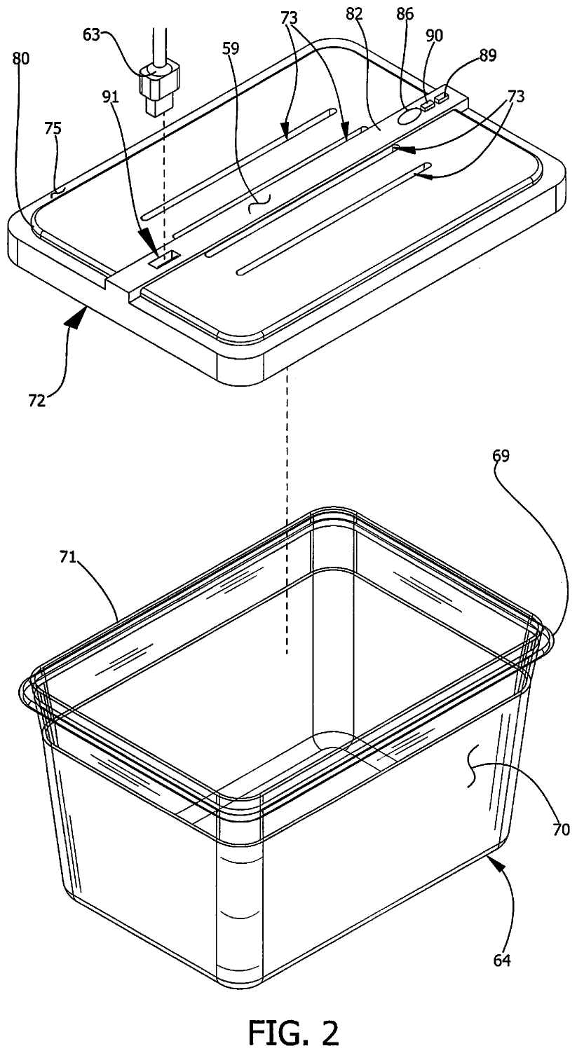

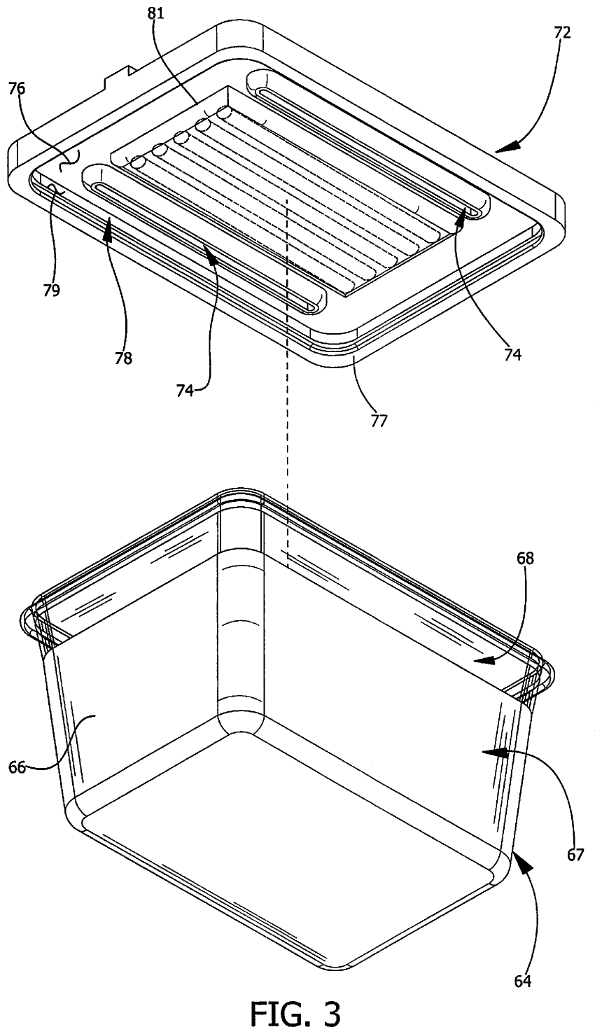

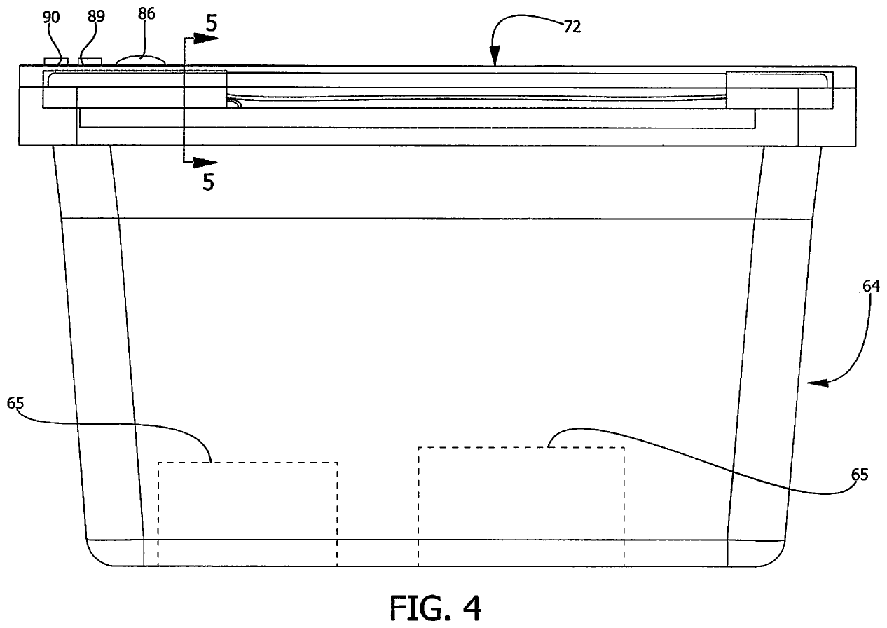

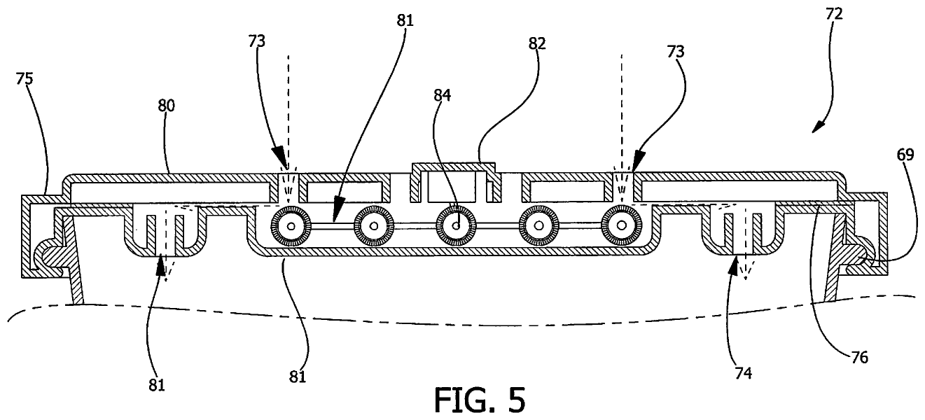

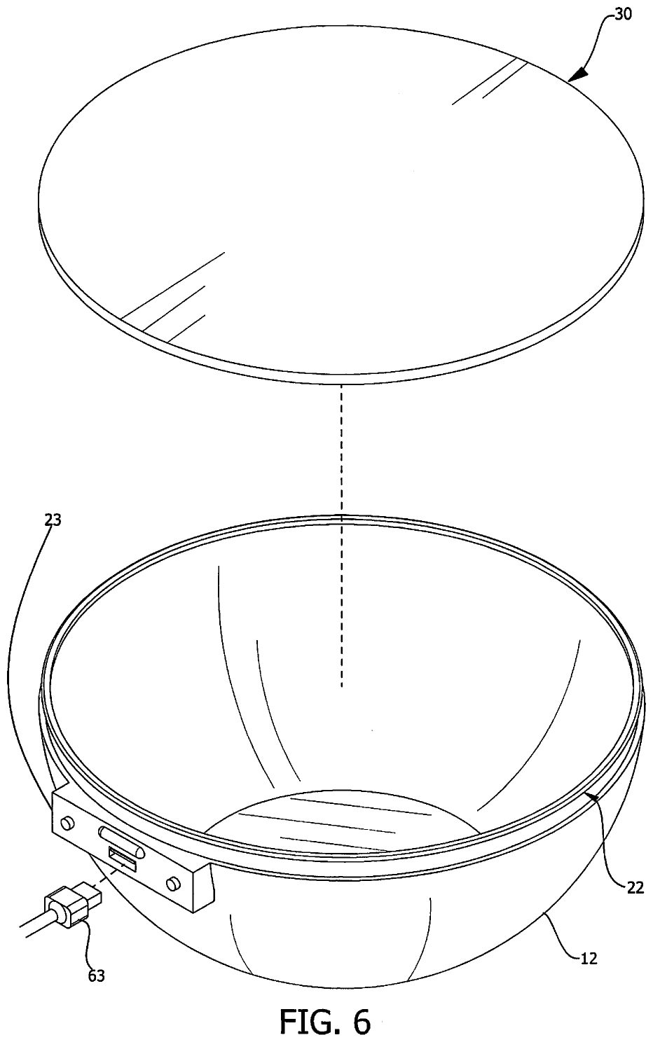

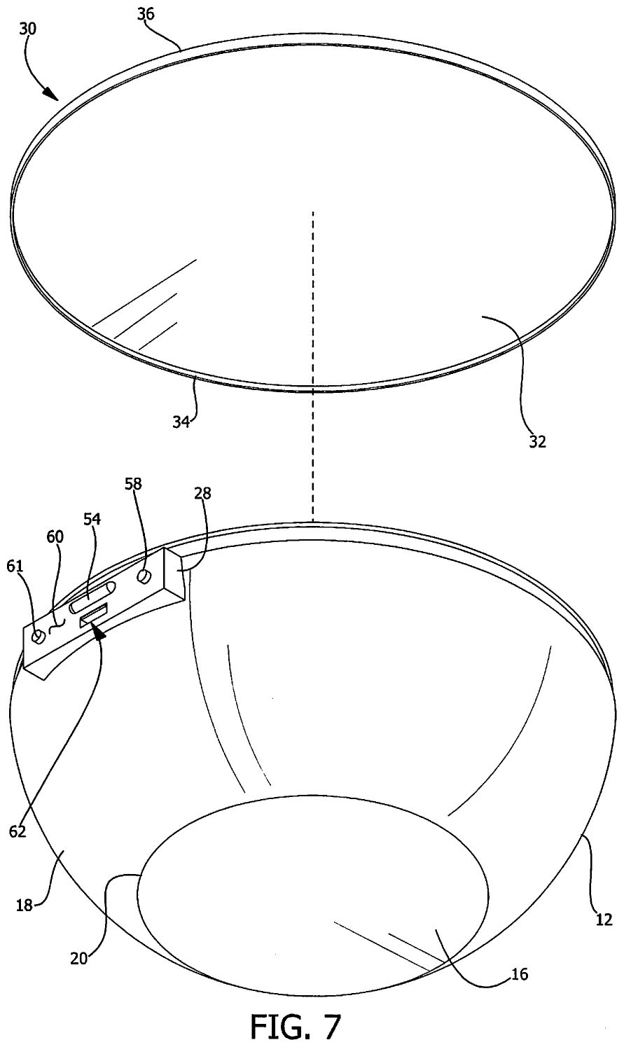

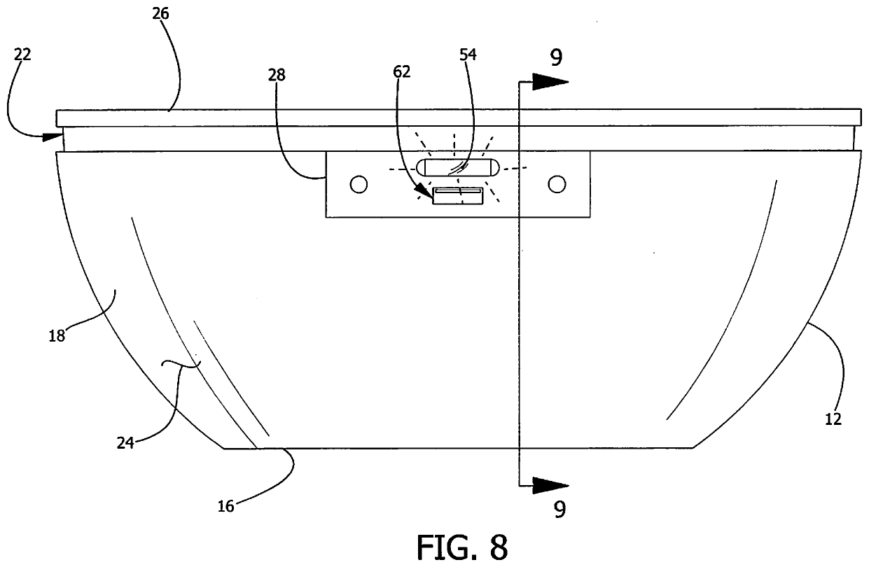

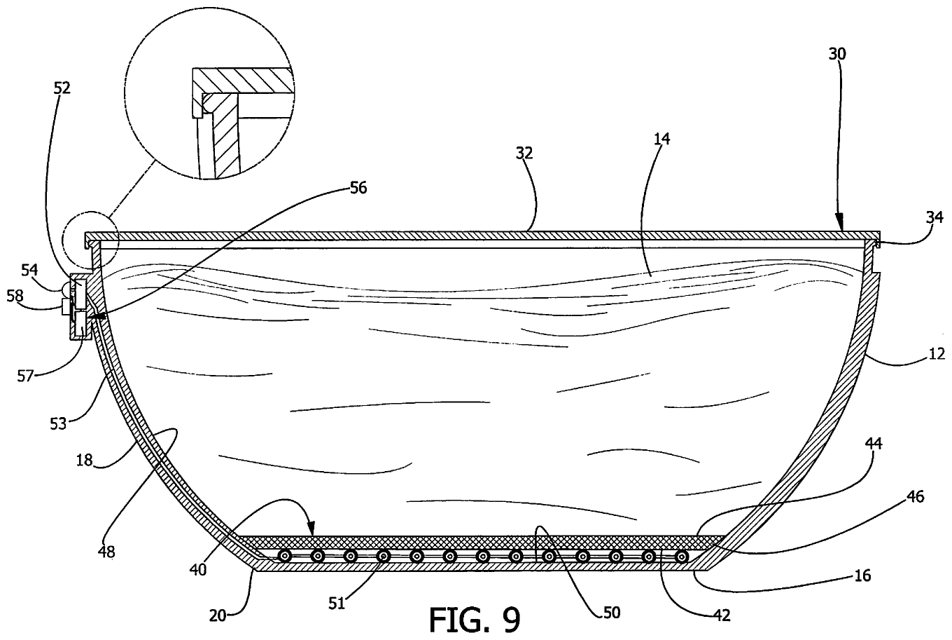

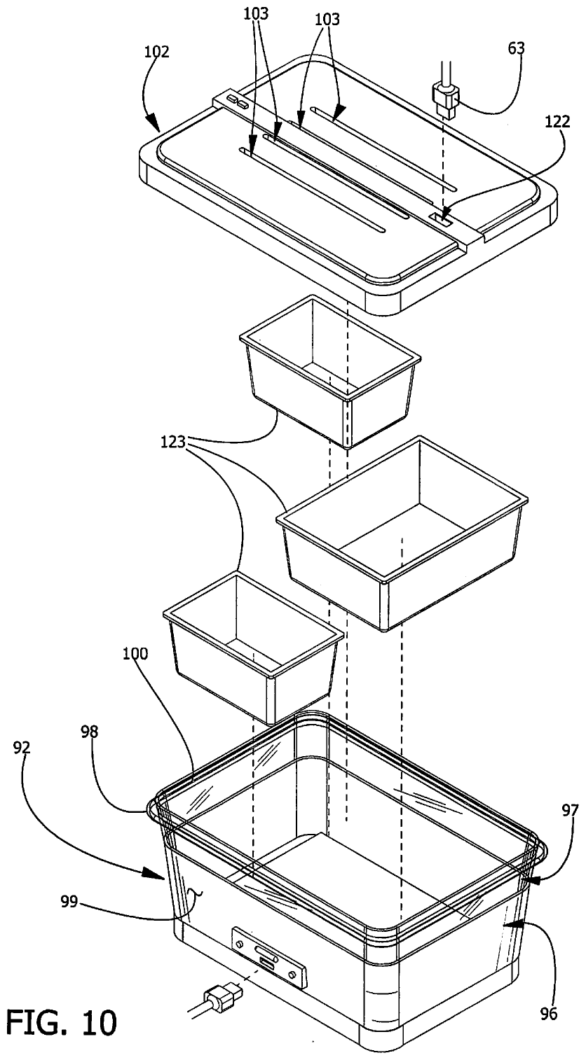

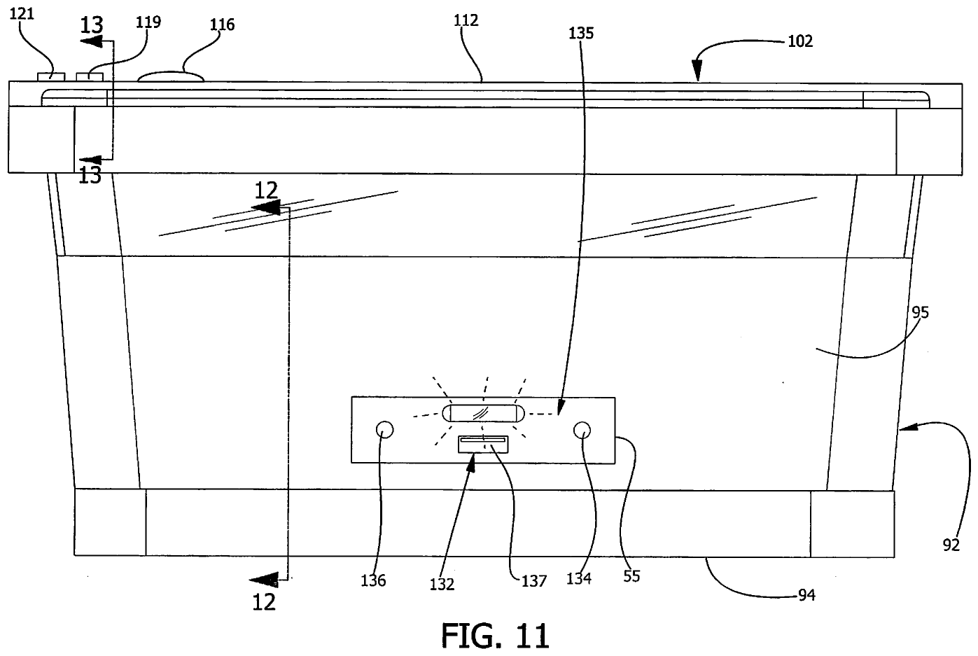

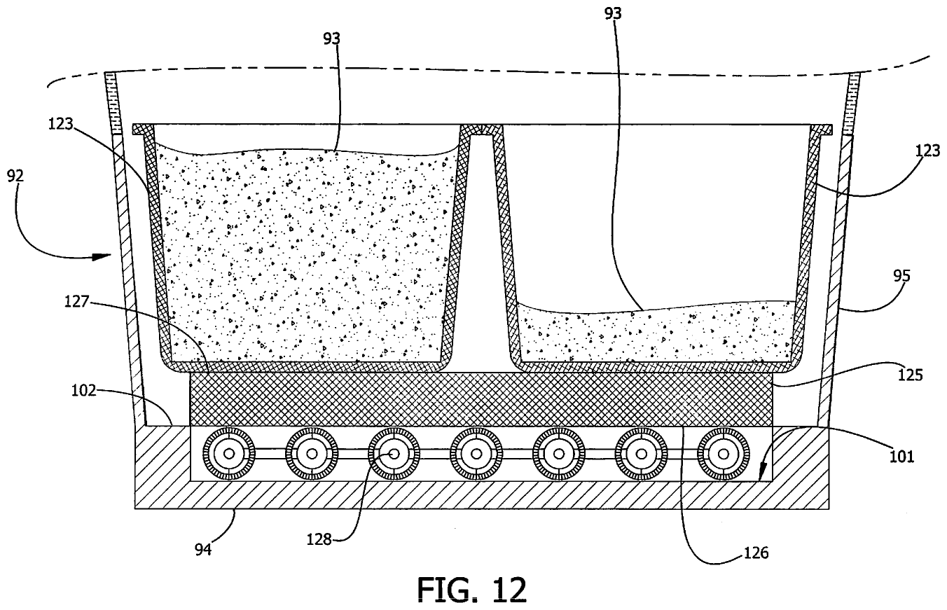

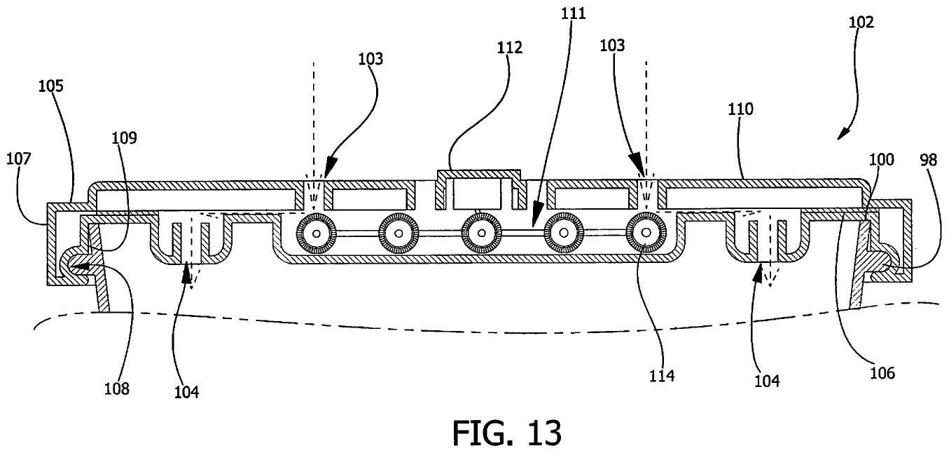

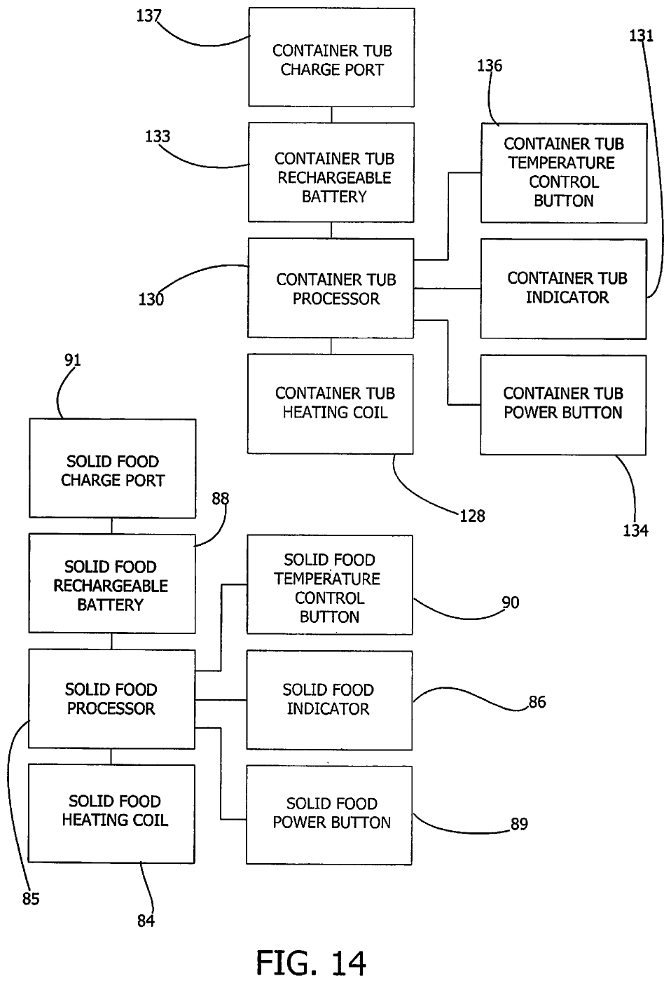

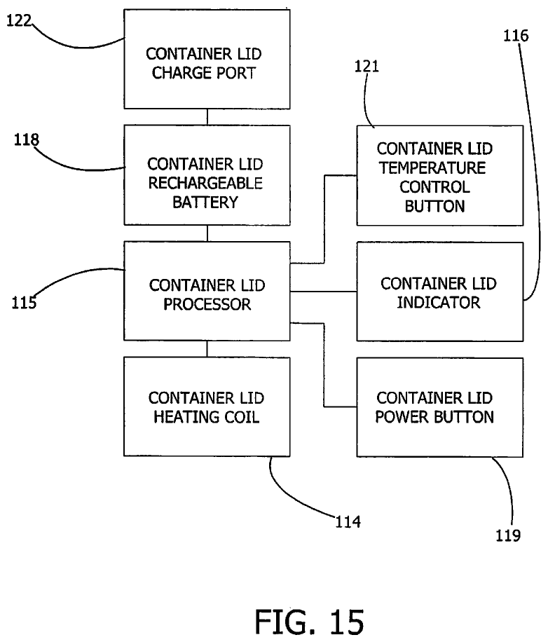

With reference now to the drawings, and in particular to FIGS. 1 through 15 thereof, a new food warming device embodying the principles and concepts of an embodiment of the disclosure and generally designated by the reference numeral 10 will be described.

As best illustrated in FIGS. 1 through 15, the food warming and storage assembly 10 generally comprises a bowl 12 that is comprised of a fluid impermeable material to store a liquid food 14. The bowl 12 is comprised of a thermally insulating material to inhibit thermal communication between the liquid food 14 and ambient air. The bowl 12 has a bottom wall 16 and an outer wall 18 curving upwardly from a perimeter 20 of the bottom wall 16 and the bowl 12 has a recess 22 extending into an outer surface 24 of the outer wall 18. The recess 22 is oriented to extend around a full circumference of the outer wall 18 and the recess 22 is spaced downwardly from a top edge 26 of the outer wall 18. The bowl 12 has a control housing 28 extending away from the outer surface 24 of the outer wall 18 and the control housing 28 is positioned beneath the recess 22. The liquid food 14 may be soup, stew or other type of liquid food that would be prone to spilling or running.

A bowl lid 30 is removably attachable to the bowl 12 for closing the bowl 12. The bowl lid 30 is comprised of a thermally insulating material to inhibit thermal communication between the liquid food 14 and ambient air when the bowl lid 30 is attached to the bowl 12. The bowl lid 30 has an upper wall 32 and a lip 34 extending downwardly from a perimeter 36 of the upper wall 32. The upper wall 32 lies on the top edge 26 of the outer wall 18 of the bowl 12 having the lip 34 extending downwardly along the outer surface 24 of the outer wall 18 at a point located between the recess 22 and the top edge 26 of the outer wall 18 of the bowl 12.

A bowl heating unit 38 is integrated into the bowl 12 and the bowl heating unit 38 is in thermal communication with an interior of the bowl 12 to heat the liquid food 14 when the liquid food 14 is stored in the bowl 12. The bowl heating unit 38 comprises a bowl heating plate 40 that has a bottom surface 42, a top surface 44 and a perimeter edge 46 and the perimeter edge 46 slopes outwardly between the bottom surface 42 and the top surface 44. In this way the perimeter edge 46 can conform to curvature of an inside surface 48 of the outer wall 18 of the bowl 12 having the lower surface 42 being spaced from a top surface 50 of the bottom wall 16 of the bowl 12. The bowl heating plate 40 is comprised of a thermally conductive material and the perimeter edge 46 is continuously arcuate such that the bowl heating plate 40 has a disk shape.

A bowl heating coil 51 is positioned between the lower surface 42 of the bowl heating plate 40 and the top surface 50 of the bottom wall 16 of the bowl 12. The bowl heating coil 51 is in thermal communication with the bowl heating plate 40 such that the bowl heating coil 51 heats the bowl heating plate 40 when the bowl heating coil 51 is turned on. In this way the bowl heating plate 40 can heat the liquid food 14 in the bowl 12. The bowl heating coil 51 may comprise an electric heating coil or the like and the bowl heating coil 51 may have an operational temperature ranging between approximately 100.0 degrees Fahrenheit and 150.0 degrees Fahrenheit.

The bowl heating unit 38 includes a bowl processor 52 that is integrated into the control housing 28 on the outer wall 18 of the bowl 12 and the bowl processor 52 is electrically coupled to the bowl heating coil 51. The bowl heating unit 38 includes a conductor 53 that is integrated into the outer wall 18 of the bowl 12. The conductor 53 is comprised of an electrically conductive material and the conductor 53 is electrically coupled between the bowl processor 52 and the bowl heating coil 51. The bowl heating unit 38 includes a bowl indicator 54 that is integrated into the control housing 28 thereby facilitating the bowl indicator 54 to emit a visual alert when the bowl indicator 54 is turned on. The bowl indicator 54 is electrically coupled to the bowl processor 52 and the bowl indicator 54 is turned on when the bowl heating coil 51 has been actuated for a pre-determined duration of time to visually indicate the liquid food 14 in the bowl 12 has been heated. The bowl indicator 54 may comprise a light emitting diode or other type of electronic light emitter and the predetermined duration of time may be at least 60.0 seconds.

The bowl heating unit 38 includes a bowl power supply 56 that is integrated into the control housing and the bowl power supply 56 is electrically coupled to the bowl processor 52. The bowl power supply 56 comprises a bowl rechargeable battery 57 that is positioned in the control housing 28 and the bowl rechargeable battery 57 is electrically coupled to the bowl processor 52. The bowl power supply 56 includes a bowl power button 58 that is movably integrated into a distal surface 60 of the control housing 28. The bowl power button 58 is electrically coupled to the bowl processor 52 and the bowl power button 58 turns the bowl processor 52 on and off.

The bowl power supply 56 includes a bowl temperature control button 61 that is movably integrated into the distal surface 60 of the control housing 28 and the bowl temperature control button 61 is electrically coupled to the bowl processor 52. The bowl temperature control button 61 increases an operational temperature of the bowl heating coil 51 toward a maximum temperature each time the bowl temperature control button 61 is depressed. The bowl power supply 56 includes a bowl charge port 62 that is recessed into the distal surface 60 of the control housing 28 to facilitate the bowl charge port 62 to insertably receive a charge cord 63. Additionally, the bowl charge port 62 is electrically coupled to the bowl rechargeable battery 57 for charging the bowl rechargeable battery 57.

A solid food tub 64 is comprised of a fluid impermeable material to facilitate the solid food tub 64 to contain a solid food 65. The solid food 65 may be meat, pastries, sandwiches or any other solid food that is not prone to spilling or running. The solid food tub 64 is comprised of a thermally insulating material to inhibit thermal communication between the solid food 65 and ambient air. The solid food tub 64 has an exterior wall 66 and the exterior wall 66 has a lower portion 67 that is comprised of an opaque material to inhibit light from passing through the lower portion 67. The exterior wall 66 has an upper portion 68 that is comprised of a translucent material to pass light through the upper portion 68. The exterior wall 66 has a lip 69 extending outwardly from an outer surface 70 of the exterior wall 66; the lip 69 extends around a full perimeter of the exterior wall 66 and the lip 69 is spaced downwardly from an upper edge 71 of the exterior wall 66.

A solid food lid 72 is provided and the solid food lid 72 is removably attachable to the solid food tub 64. The solid food lid 72 is comprised of a thermally insulating material to inhibit thermal communication between the solid food 65 in the solid food tub 64 and ambient air. The solid food lid 72 has a plurality of air inlets 73 and a plurality of air outlets 74 to pass air through the solid food lid 72. The solid food lid 72 has an upper surface 75, a lower surface 76 and a lip 77 that extends downwardly from the lower surface 76 of the solid food lid 72. The lip 77 on the solid food lid 72 has a slot 78 extending into an inwardly facing surface 79 of the lip 77 and the slot 78 extends along a full perimeter of the lip 77. Additionally, the solid food lid 72 has a prominence 80 extending upwardly from the upper surface 75.

The lower surface 42 resting on the upper edge 71 of the exterior wall 66 of the solid food tub 64 having the lip 69 on the exterior wall 66 of the solid food tub 64 being positioned in the slot 78 in the inwardly facing surface 79 of the lip 69 for retaining the solid food lid 72 on the solid food tub 64. The solid food lid 72 is substantially hollow and each of the plurality of air inlets 73 extends through the prominence 80 and the lower surface 42 of the solid food lid 72. Each of the plurality of air inlets 73 is elongated to extend along a substantial width of the solid food lid 72.

The solid food lid 72 has a heating coil chamber 81 that is located within the solid food lid 72 and the heating coil chamber 81 is in fluid communication with the plurality of plurality of air inlets 73. Each of the plurality of air outlets 74 is integrated into the lower surface 42 of the solid food lid 72 and each of the pair of air outlets 74 is positioned on opposing sides of the heating coil chamber 81. Additionally, each of the plurality of air outlets 74 is elongated to extend along a substantial width of the solid food lid 72 and each of the pair of air outlets 74 is in fluid communication with the heating coil chamber 81. The solid food lid 72 has a control housing 82 extending upwardly from the prominence 80 and the control housing 82 on the solid food lid 72 extends across a full width of the solid food lid 72. Additionally, the control housing 82 on the solid food lid 72 is centrally located on the solid food lid 72.

A solid food heating unit 83 is integrated into the solid food lid 72 and the solid food heating unit 83 is in thermal communication with the plurality of air inlets 73 and the plurality of air outlets 74. In this way the solid food heating unit 83 can heat the air passing through the solid food lid 72 and into the solid food tub 64 thereby heating the solid food 65 contained in the solid food tub 64. The solid food heating unit 83 comprises a solid food heating coil 84 that is positioned within the heating coil chamber 81 and the solid food heating coil 84 is in thermal communication with an interior of the heating coil chamber 81. In this way the solid food heating coil 84 can heat the air passing through the plurality of air inlets 73 and the plurality of air outlets 74 thereby heating the solid food 65 in the solid food tub 64. The solid food heating coil 84 may comprise an electric heating coil or the like with an operational temperature ranging between approximately 100.0 degrees Fahrenheit and 150.0 degrees Fahrenheit.

The solid food heating unit 83 includes a solid food processor 85 that is integrated into the control housing 82 on the solid food lid 72 and the solid food processor 85 is electrically coupled to the solid food heating coil 84. The solid food heating unit 83 includes a solid food indicator 86 that is integrated into the control housing 82 on the solid food lid 72 thereby facilitating the solid food indicator 86 to emit a visual alert when the solid food indicator 86 is turned on. The solid food indicator 86 is electrically coupled to the solid food processor 85 and the solid food indicator 86 is turned on when the solid food heating coil 84 has been actuated for a pre-determined duration of time. In this way the solid food indicator 86 can visually indicate the solid food 65 in the solid food tub 64 has been heated. The solid food indicator 86 may comprise a light emitting diode or the like and the predetermined duration of time may be at least 60.0 seconds.

A solid food power supply 87 is integrated into the control housing 82 on the solid food lid 72 and the solid food power supply 87 is electrically coupled to the solid food processor 85. The solid food power supply 87 comprises a solid food rechargeable battery 88 that is positioned in the control housing on the solid food lid 72. Additionally, the solid food rechargeable battery 88 is electrically coupled to the solid food processor 85. The solid food power supply 87 includes a solid food power button 89 that is movably integrated into a distal surface 59 of the control housing 82 on the solid food lid 72. The solid food power button 89 is electrically coupled to the solid food processor 85 and the solid food power button 89 for turning the solid food processor 85 on and off.

The solid food power supply 87 includes a solid food temperature control button 90 that is movably integrated into the distal surface 59 of the control housing 82 on the solid food lid 72. The solid food temperature control button 90 is electrically coupled to the solid food processor 85 and the solid food temperature control button 90 increases an operational temperature of the solid food heating coil 84 toward a maximum temperature each time the solid food temperature control button 90 is depressed. The solid food power supply 87 includes a solid food charge port 91 that is recessed into the distal surface 59 of the control housing 82 on the solid food lid 72 to facilitate the solid food charge port 91 to insertably receive a charge cord 63. Furthermore, the solid food charge port 91 is electrically coupled to the solid food rechargeable battery 88 for charging the solid food rechargeable battery 88.

A container tub 92 is comprised of a fluid impermeable material to contain a food product 93 and the container tub 92 is comprised of a thermally insulating material to inhibit thermal communication between the food product 93 and ambient air. The container tub 92 has a basal wall 94 and an outermost wall 95 extending upwardly from the basal wall 94. The outermost wall 95 has a bottom portion 96 that is comprised of an opaque material to inhibit light from passing through the bottom portion 96. Additionally, the outermost wall 95 has a top portion 97 that is comprised of a translucent material to pass light through the top portion 97. The outermost wall 95 has a lip 98 extending outwardly from an outer surface 99 of the outermost wall 95 and the lip 98 on the outermost wall 95 extends around a full perimeter of the outermost wall 95. The lip 98 on the outermost wall 95 is spaced downwardly from an upper edge 100 of the outermost wall 95. Additionally, the container tub 92 has a heating coil recess 101 extending downwardly into a topmost surface 102 of the basal wall 94. The container tub 92 has a control housing 55 disposed on the outermost wall 95 of the container tub 92.

A container lid 102 is removably attachable to the container tub 92 and the container lid 102 is comprised of a thermally insulating material to inhibit thermal communication between the food product 93 in the container tub 92 and ambient air. The container lid 102 has a plurality of air inlets 103 and a plurality of air outlets 104 to pass air through the container lid 102. The container lid 102 has an uppermost surface 105, a lowermost surface 106 and a lip 107 extending downwardly from the lowermost surface 106 of the container lid 102. The lip 98 on the container lid 102 has a slot 108 extending into an inwardly facing surface 109 of the lip 98 on the container lid 102 and the slot 108 associated with the container lid 102 extends along a full perimeter of the lip 98 on the container lid 102.

The container lid 102 has a prominence 110 extending upwardly from the uppermost surface 105. The lowermost surface 106 rests on the upper edge 100 of the outermost wall 95 of the container tub 92 having the lip 98 on the outermost wall 95 of the container tub 92 being positioned in the slot 108 in the inwardly facing surface 109 of the lip 98 on the container lid 102 for retaining the container lid 102 on the container tub 92. The container lid 102 is substantially hollow and each of the plurality of air inlets 103 in the container lid 102 extends through the prominence 110 and the lowermost surface 106 of the container lid 102. Additionally, each of the plurality of air inlets 103 in the container lid 102 is elongated to extend along a substantial width of the container lid 102.

The container lid 102 has a heating coil chamber 111 that is located within the container lid 102 and the heating coil chamber 111 in the container lid 102 is in fluid communication with the plurality of plurality of air inlets 103 in the container lid 102. Each of the plurality of air outlets 104 in the container lid 102 is integrated into the lowermost surface 106 of the container lid 102. Each of the pair of air outlets 104 in the container lid 102 is positioned on opposing sides of the heating coil chamber 111 in the container lid 102. Each of the plurality of air outlets 104 in the container lid 102 is elongated to extend along a substantial width of the container lid 102 and each of the pair of air outlets 104 in the container lid 102 is in fluid communication with the heating coil chamber 111 in the container lid 102. The container lid 102 has a control housing 112 extending upwardly from the prominence 110 on the container lid 102. The control housing 112 on the container lid 102 extends across a full width of the container lid 102. Additionally, the control housing 112 on the container lid 102 is centrally located on the container lid 102.

A container lid heating unit 113 is integrated into the container lid 102 and the container lid heating unit 113 is in thermal communication with the plurality of air inlets 103 in the container lid 102 and the plurality of air outlets 104 in the container lid 102. In this way the container lid heating unit 113 can heat the air passing through the container lid 102 and into the container tub 92 thereby heating the food product 93 contained in the container tub 92. The container lid heating unit 113 comprises a container lid heating coil 114 that is positioned within the heating coil chamber 111 in the container lid 102. The container lid heating coil 114 is in thermal communication with an interior of the heating coil chamber 111 in the container lid 102. In this way the container lid heating coil 114 can heat the air passing through the plurality of air inlets 103 in the container lid 102 and the plurality of air outlets 104 in the container lid 102 thereby heating the container lid 102 in the container tub 92. The container lid heating coil 114 may comprise an electric heating coil or the like and the container lid heating coil 114 may have an operational temperature ranging between approximately 100.0 degrees Fahrenheit and 150.0 degrees Fahrenheit.

The container lid heating unit 113 includes a container lid processor 115 that is integrated into the control housing 112 on the container lid 102 and the container lid processor 115 is electrically coupled to the container lid heating coil 114. The container lid heating unit 113 includes a container lid indicator 116 that is integrated into the control housing on the container lid 102 thereby facilitating the container lid indicator 116 to emit a visual alert when the container lid indicator 116 is turned on. The container lid indicator 116 is electrically coupled to the container lid processor 115 and the container lid indicator 116 is turned on when the container lid heating coil 114 has been actuated for a pre-determined duration of time. In this way the container lid indicator 116 can visually indicate the container lid 102 in the container tub 92 has been heated.

A container lid power supply 117 is integrated into the control housing 112 on the container lid 102 and the container lid power supply 117 is electrically coupled to the container lid processor 115. The container lid power supply 117 comprises a container lid rechargeable battery 118 that is positioned in the control housing 112 on the container lid 102. The container lid rechargeable battery 118 is electrically coupled to the container lid processor 115. The container lid power supply 117 includes a container lid power button 119 that is movably integrated into a distal surface 120 of the control housing 112 on the container lid 102. The container lid power button 119 is electrically coupled to the container lid processor 115 and the container lid power button 119 turns the container lid processor 115 on and off.

A container lid temperature control button 121 is movably integrated into the distal surface 120 of the control housing 112 on the container lid 102 and the container lid temperature control button 121 is electrically coupled to the container lid processor 115. The container lid temperature control button 121 increases an operational temperature of the container lid heating coil 114 toward a maximum temperature each time the container lid temperature control button 121 is depressed. The container lid power supply 117 includes a container lid charge port 122 that is recessed into the distal surface 120 of the control housing 112 on the container lid 102 to facilitate the container lid charge port 122 to insertably receive a charge cord 63. The container lid charge port 122 is electrically coupled to the container lid rechargeable battery 118 for charging the container lid rechargeable battery 118.

A plurality of food containers 123 is provided and each of the plurality of food containers 123 is comprised of a fluid impermeable material for containing a food product 93. Each of the plurality of food containers 123 is positionable in the container tub 92 for storing and transporting the plurality of food containers 123. Additionally, each of the plurality of food containers 123 may comprise rectangular bins or other type of food container that can contain the food product 93, which may be either a fluid food or a solid food. A container tub heating unit 124 is integrated into the container tub 92 and the container tub heating unit 124 is in thermal communication with an interior of the container tub 92 to heat the food containers 123 when the food containers 123 are stored in the container tub 92.

The container tub heating unit 124 comprises a container tub heating plate 125 that has a lower surface 126 and a top surface 127 and the container tub heating plate 125 is comprised of a thermally conductive material. The container tub heating plate 125 is positioned over the heating coil recess 101 in the topmost surface 102 of the basal wall 94 of the container tub 92 and each of the plurality of food containers 123 is positionable on the container tub heating plate 125. The container tub heating unit 124 includes a container tub heating coil 128 that is positioned in the heating coil recess 101. The container tub heating coil 128 is in thermal communication with the container tub heating plate 125 such that the container tub heating coil 128 heats the container tub heating plate 125 when the container tub heating coil 128 is turned on. In this way the container tub heating plate 125 can heat the food product 93 stored in the plurality of food containers 123.

The container tub heating unit 124 includes a container tub processor 130 that is integrated into the control housing 55 on the container tub 92 and the container tub processor 130 is electrically coupled to the container tub heating coil 128. The container tub heating unit 124 includes a container tub indicator 131 that is integrated into the control housing 55 on the container tub 92 thereby facilitating the container tub indicator 131 to emit a visual alert when the container tub indicator 131 is turned on. The container tub indicator 131 is electrically coupled to the container tub processor 130 and the container tub indicator 131 is turned on when the container tub heating coil 128 has been actuated for a pre-determined duration of time. In this way the container tub indicator 131 can visually indicate the liquid food 14 in the container tub 92 has been heated.

A container tub power supply 132 is integrated into the control housing 55 on the container tub 92 and the container tub power supply 132 is electrically coupled to the container tub processor 130. The container tub power supply 132 comprises a container tub rechargeable battery 133 that is positioned in the control housing 112 on the container lid 102. Additionally, the container tub rechargeable battery 133 is electrically coupled to the container tub processor 130. The container tub power supply 132 includes a container tub power button 134 that is movably integrated into a distal surface 135 of the control housing 55 on the container tub 92. The container tub power button 134 is electrically coupled to the container tub processor 130 and the container tub power button 134 turns the container tub processor 130 on and off.

The container tub power supply 132 includes a container tub temperature control button 136 that is movably integrated into the distal surface 135 of the control housing 55 on the container tub 92. The container tub temperature control button 136 is electrically coupled to the container tub processor 130. Additionally, the container tub temperature control button 136 increases an operational temperature of the container tub heating coil 128 toward a maximum temperature each time the container tub temperature control button 136 is depressed. The container tub power supply 132 includes a container tub charge port 137 that is recessed into the distal surface 135 of the control housing 55 on the container tub 92 to facilitate the container tub charge port 137 to insertably receive a charge cord 63. The container tub charge port 137 is electrically coupled to the container tub rechargeable battery 133 for charging the container tub rechargeable battery 133.

In use, the liquid food 14 is stored in the bowl 12, the bowl lid 30 is positioned on the bowl 12 and the bowl heating unit 38 is turned on the heat the liquid food 14 in the bowl 12. In this way the liquid food 14 can be transported or stored while being kept warm for subsequent consumption. The solid food 65 is placed in the solid food tub 64 and the solid food lid 72 is placed on the solid food tub 64. The solid food heating unit 83 is turned on the heat the solid food 65 that is placed in the solid food tub 64. In this way the solid food 65 can be transported or stored while being kept warm for subsequent consumption. The food containers 123 are filled with either a liquid food 14 or a solid food 65 and the food containers 123 are placed in the container tub 92. The container lid heating unit 113 can be turned on the heat the food containers 123 or the container tub heating unit 124 can be turned on the heat the food containers 123, depending on which would most effectively heat the food product 93 that is stored in the food containers 123.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A food warming and storage assembly for storing and warming liquid foods and solid foods, said assembly comprising:
a bowl being comprised of a fluid impermeable material wherein said bowl is configured to store a liquid food, said bowl being comprised of a thermally insulating material wherein said bowl is configured to inhibit thermal communication between the liquid food and ambient air;
a bowl lid being removably attachable to said bowl for closing said bowl, said bowl lid being comprised of a thermally insulating material wherein said bowl lid is configured to inhibit thermal communication between the liquid food and ambient air when said bowl lid is attached to said bowl;
a bowl heating unit being integrated into said bowl, said bowl heating unit being in thermal communication with an interior of said bowl wherein said bowl heating unit is configured to heat the liquid food when the liquid food is stored in said bowl;
a solid food tub being comprised of a fluid impermeable material wherein said solid food tub is configured to contain a solid food, said solid food tub being comprised of a thermally insulating material wherein said solid food tub is configured to inhibit thermal communication between the solid food and ambient air;
a solid food lid being removably attachable to said solid food tub, said solid food lid being comprised of a thermally insulating material wherein said solid food lid is configured to inhibit thermal communication between the solid food in said solid food tub and ambient air, said solid food lid having a plurality of air inlets and a plurality of air outlets wherein said plurality of air inlets and said plurality of air outlets is configured to pass air through said solid food lid;
a solid food heating unit being integrated into said solid food lid, said solid food heating unit being in thermal communication with said plurality of air inlets and said plurality of air outlets wherein said solid food heating unit is configured to heat the air passing through said solid food lid and into said solid food tub thereby heating the solid food contained in said solid food tub;
a container tub being comprised of a fluid impermeable material wherein said container tub is configured to contain a food product, said container tub being comprised of a thermally insulating material wherein said container tub is configured to inhibit thermal communication between the food product and ambient air;
a container lid being removably attachable to said container tub, said container lid being comprised of a thermally insulating material wherein said container lid is configured to inhibit thermal communication between the food product in said container tub and ambient air, said container lid having a plurality of air inlets and a plurality of air outlets wherein said plurality of air inlets and said plurality of air outlets in said container lid is configured to pass air through said container lid;
a container lid heating unit being integrated into said container lid, said container lid heating unit being in thermal communication with said plurality of air inlets in said container lid and said plurality of air outlets in said container lid wherein said container lid heating unit is configured to heat the air passing through said container lid and into said container tub thereby heating the food product contained in said container tub;
a plurality of food containers each being comprised of a fluid impermeable material wherein each of said plurality of food containers is configured to contain a food product, each of said plurality of food containers being positionable in said container tub for storing and transporting said plurality of food containers; and
a container tub heating unit being integrated into said container tub, said container tub heating unit being in thermal communication with an interior of said container tub to heat said food containers when said food containers are stored in said container tub.

2. The assembly according to claim 1, wherein:
said bowl has a bottom wall and an outer wall curving upwardly from a perimeter of said bottom wall;
said bowl has a recess extending into an outer surface of said outer wall;
said recess is oriented to extend around a full circumference of said outer wall;
said recess is spaced downwardly from a top edge of said outer wall;
said bowl has a control housing extending away from said outer surface of said outer wall;
said control housing is positioned beneath said recess;
said bowl lid has an upper wall and a lip extending downwardly from a perimeter of said upper wall; and
said upper wall lies on said top edge of outer wall of said bowl having said lip extending downwardly along said outer surface of said outer wall at a point located between said recess and said top edge of said outer wall of said bowl.

3. The assembly according to claim 2, wherein said bowl heating unit comprises:
a bowl heating plate having a lower surface, a top surface and a perimeter edge, said perimeter edge sloping outwardly between said bottom surface and said top surface thereby facilitating said perimeter edge to conform to curvature of an inside surface of said outer wall of said bowl having said lower surface being spaced from a top surface of said bottom wall of said bowl, said bowl heating plate being comprised of a thermally conductive material, said perimeter edge being continuously arcuate such that said bowl heating plate has a disk shape; and
a bowl heating coil being positioned between said lower surface of said bowl heating plate and said top surface of said bottom wall of said bowl, said bowl heating coil being in thermal communication with said bowl heating plate such that said bowl heating coil heats said bowl heating plate when said bowl heating coil is turned on wherein said bowl heating plate is configured to heat the liquid food in said bowl.

4. The assembly according to claim 3, wherein said bowl heating unit comprises:
a bowl processor being integrated into said control housing on said outer wall of said bowl, said bowl processor being electrically coupled to said bowl heating coil;
a conductor being integrated into said outer wall of said bowl, said conductor being comprised of an electrically conductive material, said conductor being electrically coupled between said bowl processor and said bowl heating coil; and
a bowl indicator being integrated into said control housing thereby facilitating said bowl indicator to emit a visual alert when said bowl indicator is turned on, said bowl indicator being electrically coupled to said bowl processor, said bowl indicator being turned on when said bowl heating coil has been actuated for a pre-determined duration of time wherein said bowl indicator is configured to visually indicate the liquid food in said bowl has been heated.

5. The assembly according to claim 4, wherein said bowl heating unit includes a bowl power supply being integrated into said control housing, said bowl power supply being electrically coupled to said bowl processor, said bowl power supply comprising:
a bowl rechargeable battery being positioned in said control housing, said bowl rechargeable battery being electrically coupled to said bowl processor;
a bowl power button being movably integrated into a distal surface of said control housing, said bowl power button being electrically coupled to said bowl processor, said bowl power button turning said bowl processor on and off;
a bowl temperature control button being movably integrated into said distal surface of said control housing, said bowl temperature control button being electrically coupled to said bowl processor, said bowl temperature control button increasing an operational temperature of said bowl heating coil toward a maximum temperature each time said bowl temperature control button is depressed; and
a bowl charge port being recessed into said distal surface of said control housing to facilitate said bowl charge port to insertably receive a charge cord, said bowl charge port being electrically coupled to said bowl rechargeable battery for charging said bowl rechargeable battery.

6. The assembly according to claim 1, wherein:
said solid food tub has an exterior wall;
said exterior wall has a lower portion being comprised of an opaque material wherein said lower portion is configured to inhibit light from passing through said lower portion;
said exterior wall has an upper portion being comprised of a translucent material wherein said upper portion is configured to pass light through said upper portion;
said exterior wall has a lip extending outwardly from an outer surface of said exterior wall;
said lip extending around a full perimeter of said exterior wall; and
said lip is spaced downwardly from an upper edge of said exterior wall.

7. The assembly according to claim 6, wherein:
said solid food lid has an upper surface and a lower surface and a lip extending downwardly from said lower surface of said solid food lid;
said lip on said solid food lid has a slot extending into an inwardly facing surface of said lip;
said slot extends along a full perimeter of said lip;
said solid food lid has a prominence extending upwardly from said upper surface;
said lower surface rests on said upper edge of said exterior wall of said solid food tub having said lip on said exterior wall of said solid food tub being positioned in said slot in said inwardly facing surface of said lip for retaining said solid food lid on said solid food tub.

8. The assembly according to claim 1, wherein:
said solid food lid is substantially hollow;
each of said plurality of air inlets extends through said prominence and said lower surface of said solid food lid;
each of said plurality of air inlets is elongated to extend along a substantial width of said solid food lid;
said solid food lid has a heating coil chamber being located within said solid food lid;
said heating coil chamber being in fluid communication with said plurality of plurality of air inlets;
each of said plurality of air outlets is integrated into said lower surface of said solid food lid;
each of said pair of air outlets is positioned on opposing sides of said heating coil chamber;
each of said plurality of air outlets is elongated to extend along a substantial width of said solid food lid;
each of said pair of air outlets is in fluid communication with said heating coil chamber;
said solid food lid has a control housing extending upwardly from said prominence;
said control housing on said solid food lid extends across a full width of said solid food lid; and
said control housing on said solid food lid is centrally located on said solid food lid.

9. The assembly according to claim 8, wherein said solid food heating unit comprises a solid food heating coil being positioned within said heating coil chamber, said solid food heating coil being in thermal communication with an interior of said heating coil chamber wherein said solid food heating coil is configured to heat the air passing through said plurality of air inlets and said plurality of air outlets thereby heating the solid food in said solid food tub.

10. The assembly according to claim 9, wherein said solid food heating unit includes:
a solid food processor being integrated into said control housing on said solid food lid, said solid food processor being electrically coupled to said solid food heating coil; and
a solid food indicator being integrated into said control housing on said solid food lid thereby facilitating said solid food indicator to emit a visual alert when said solid food indicator is turned on, said solid food indicator being electrically coupled to said solid food processor, said solid food indicator being turned on when said solid food heating coil has been actuated for a pre-determined duration of time wherein said solid food indicator is configured to visually indicate the solid food in said solid food tub has been heated.

11. The assembly according to claim 10, wherein said solid food heating unit includes a solid food power supply being integrated into said control housing on said solid food lid, said solid food power supply being electrically coupled to said solid food processor, said solid food power supply comprising:
a solid food rechargeable battery being positioned in said control housing on said solid food lid, said solid food rechargeable battery being electrically coupled to said solid food processor;
a solid food power button being movably integrated into a distal surface of said control housing on said solid food lid, said solid food power button being electrically coupled to said solid food processor, said solid food power button turning said solid food processor on and off;
a solid food temperature control button being movably integrated into said distal surface of said control housing on said solid food lid, said solid food temperature control button being electrically coupled to said solid food processor, said solid food temperature control button increasing an operational temperature of said solid food heating coil toward a maximum temperature each time said solid food temperature control button is depressed; and
a solid food charge port being recessed into said distal surface of said control housing on said solid food lid to facilitate said solid food charge port to insertably receive a charge cord, said solid food charge port being electrically coupled to said solid food rechargeable battery for charging said solid food rechargeable battery.

12. The assembly according to claim 1, wherein:
said container tub has basal wall and an outermost wall extending upwardly from said basal wall;
said outermost wall has a bottom portion being comprised of an opaque material wherein said bottom portion is configured to inhibit light from passing through said bottom portion;
said outermost wall has a top portion being comprised of a translucent material wherein said top portion is configured to pass light through said top portion;
said outermost wall has a lip extending outwardly from an outer surface of said outermost wall;
said lip on said outermost wall extends around a full perimeter of said outermost wall;
said lip on said outermost wall is spaced downwardly from an upper edge of said outermost wall;
said container tub has a heating coil recess extending downwardly into a topmost surface of said basal wall; and
said container tub has a control housing being disposed on said outermost wall of said container tub.

13. The assembly according to claim 12, wherein:
said container lid has an uppermost surface and a lowermost surface and a lip extending downwardly from said lowermost surface of said container lid;
said lip on said container lid has a slot extending into an inwardly facing surface of said lip on said container lid;
said slot associated with said container lid extends along a full perimeter of said lip on said container lid;
said container lid has a prominence extending upwardly from said uppermost surface; and
said lowermost surface rests on said upper edge of said outermost wall of said container tub having said lip on said outermost wall of said container tub being positioned in said slot in said inwardly facing surface of said lip on said container lid for retaining said container lid on said container tub.

14. The assembly according to claim 13, wherein:
said container lid is substantially hollow;
each of said plurality of air inlets in said container lid extends through said prominence and said lowermost surface of said container lid;
each of said plurality of air inlets in said container lid is elongated to extend along a substantial width of said container lid;
said container lid has a heating coil chamber being located within said container lid;
said heating coil chamber in said container lid is in fluid communication with said plurality of plurality of air inlets in said container lid;
each of said plurality of air outlets in said container lid is integrated into said lowermost surface of said container lid;
each of said pair of air outlets in said container lid is positioned on opposing sides of said heating coil chamber in said container lid;
each of said plurality of air outlets in said container lid is elongated to extend along a substantial width of said container lid;
each of said pair of air outlets in said container lid is in fluid communication with said heating coil chamber in said container lid;
said container lid has a control housing extending upwardly from said prominence on said container lid;
said control housing on said container lid extends across a full width of said container lid; and
said control housing on said container lid is centrally located on said container lid.

15. The assembly according to claim 14, wherein said container lid heating unit comprises:
a container lid heating coil being positioned within said heating coil chamber in said container lid, said container lid heating coil being in thermal communication with an interior of said heating coil chamber in said container lid wherein said container lid heating coil is configured to heat the air passing through said plurality of air inlets in said container lid and said plurality of air outlets in said container lid thereby heating the container lid in said container tub;
a container lid processor being integrated into said control housing on said container lid, said container lid processor being electrically coupled to said container lid heating coil; and
a container lid indicator being integrated into said control housing on said container lid thereby facilitating said container lid indicator to emit a visual alert when said container lid indicator is turned on, said container lid indicator being electrically coupled to said container lid processor, said container lid indicator being turned on when said container lid heating coil has been actuated for a pre-determined duration of time wherein said container lid indicator is configured to visually indicate the container lid in said container tub has been heated.

16. The assembly according to claim 15, further comprising a container lid power supply being integrated into said control housing on said container lid, said container lid power supply being electrically coupled to said container lid processor, said container lid power supply comprising:
a container lid rechargeable battery being positioned in said control housing on said container lid, said container lid rechargeable battery being electrically coupled to said container lid processor;
a container lid power button being movably integrated into a distal surface of said control housing on said container lid, said container lid power button being electrically coupled to said container lid processor, said container lid power button turning said container lid processor on and off;
a container lid temperature control button being movably integrated into said distal surface of said control housing on said container lid, said container lid temperature control button being electrically coupled to said container lid processor, said container lid temperature control button increasing an operational temperature of said container lid heating coil toward a maximum temperature each time said container lid temperature control button is depressed; and
a container lid charge port being recessed into said distal surface of said control housing on said container lid to facilitate said container lid charge port to insertably receive a charge cord, said container lid charge port being electrically coupled to said container lid rechargeable battery for charging said container lid rechargeable battery.

17. The assembly according to claim 12, wherein said container tub heating unit comprises:
a container tub heating plate having a lower surface and a top surface, said container tub heating plate being comprised of a thermally conductive material, said container tub heating plate being positioned over said heating coil recess in said topmost surface of said basal wall of said container tub, each of said plurality of food containers being positionable on said container tub heating plate;
a container tub heating coil being positioned in said heating coil recess, said container tub heating coil being in thermal communication with said container tub heating plate such that said container tub heating coil heats said container tub heating plate when said container tub heating coil is turned on wherein said container tub heating plate is configured to heat the food product stored in said plurality of food containers;
a container tub processor being integrated into said control housing on said container lid, said container tub processor being electrically coupled to said container tub heating coil; and
a container tub indicator being integrated into said control housing on said container lid thereby facilitating said container tub indicator to emit a visual alert when said container tub indicator is turned on, said container tub indicator being electrically coupled to said container tub processor, said container tub indicator being turned on when said container tub heating coil has been actuated for a pre-determined duration of time wherein said container tub indicator is configured to visually indicate the liquid food in said container tub has been heated.

18. The assembly according to claim 17, further comprising a container tub power supply being integrated into said control housing on said container tub, said container tub power supply being electrically coupled to said container tub processor, said container tub power supply comprising:
a container tub rechargeable battery being positioned in said control housing on said container tub, said container tub rechargeable battery being electrically coupled to said container tub processor;
a container tub power button being movably integrated into a distal surface of said control housing on said container tub, said container tub power button being electrically coupled to said container tub processor, said container tub power button turning said container tub processor on and off;
a container tub temperature control button being movably integrated into said distal surface of said control housing on said container tub, said container tub temperature control button being electrically coupled to said container tub processor, said container tub temperature control button increasing an operational temperature of said container tub heating coil toward a maximum temperature each time said container tub temperature control button is depressed; and
a container tub charge port being recessed into said distal surface of said control housing on said container tub to facilitate said container tub charge port to insertably receive a charge cord, said container tub charge port being electrically coupled to said container tub rechargeable battery for charging said container tub rechargeable battery.

19. A food warming and storage assembly for storing and warming liquid foods and solid foods, said assembly comprising:
a bowl being comprised of a fluid impermeable material wherein said bowl is configured to store a liquid food, said bowl being comprised of a thermally insulating material wherein said bowl is configured to inhibit thermal communication between the liquid food and ambient air, said bowl having a bottom wall and an outer wall curving upwardly from a perimeter of said bottom wall, said bowl having a recess extending into an outer surface of said outer wall, said recess being oriented to extend around a full circumference of said outer wall, said recess being spaced downwardly from a top edge of said outer wall, said bowl having a control housing extending away from said outer surface of said outer wall, said control housing being positioned beneath said recess;
a bowl lid being removably attachable to said bowl for closing said bowl, said bowl lid being comprised of a thermally insulating material wherein said bowl lid is configured to inhibit thermal communication between the liquid food and ambient air when said bowl lid is attached to said bowl, said bowl lid having an upper wall and a lip extending downwardly from a perimeter of said upper wall, said upper wall lying on said top edge of said outer wall of said bowl having said lip extending downwardly along said outer surface of said outer wall at a point located between said recess and said top edge of said outer wall of said bowl;
a bowl heating unit being integrated into said bowl, said bowl heating unit being in thermal communication with an interior of said bowl wherein said bowl heating unit is configured to heat the liquid food when the liquid food is stored in said bowl, said bowl heating unit comprising:
a bowl heating plate having a bottom surface, a top surface and a perimeter edge, said perimeter edge sloping outwardly between said bottom surface and said top surface thereby facilitating said perimeter edge to conform to curvature of an inside surface of said outer wall of said bowl having said lower surface being spaced from a top surface of said bottom wall of said bowl, said bowl heating plate being comprised of a thermally conductive material, said perimeter edge being continuously arcuate such that said bowl heating plate has a disk shape;
a bowl heating coil being positioned between said lower surface of said bowl heating plate and said top surface of said bottom wall of said bowl, said bowl heating coil being in thermal communication with said bowl heating plate such that said bowl heating coil heats said bowl heating plate when said bowl heating coil is turned on wherein said bowl heating plate is configured to heat the liquid food in said bowl;
a bowl processor being integrated into said control housing on said outer wall of said bowl, said bowl processor being electrically coupled to said bowl heating coil;
a conductor being integrated into said outer wall of said bowl, said conductor being comprised of an electrically conductive material, said conductor being electrically coupled between said bowl processor and said bowl heating coil;
a bowl indicator being integrated into said control housing thereby facilitating said bowl indicator to emit a visual alert when said bowl indicator is turned on, said bowl indicator being electrically coupled to said bowl processor, said bowl indicator being turned on when said bowl heating coil has been actuated for a pre-determined duration of time wherein said bowl indicator is configured to visually indicate the liquid food in said bowl has been heated; and
a bowl power supply being integrated into said control housing, said bowl power supply being electrically coupled to said bowl processor, said bowl power supply comprising:
a bowl rechargeable battery being positioned in said control housing, said bowl rechargeable battery being electrically coupled to said bowl processor;
a bowl power button being movably integrated into a distal surface of said control housing, said bowl power button being electrically coupled to said bowl processor, said bowl power button turning said bowl processor on and off;
a bowl temperature control button being movably integrated into said distal surface of said control housing, said bowl temperature control button being electrically coupled to said bowl processor, said bowl temperature control button increasing an operational temperature of said bowl heating coil toward a maximum temperature each time said bowl temperature control button is depressed; and
a bowl charge port being recessed into said distal surface of said control housing to facilitate said bowl charge port to insertably receive a charge cord, said bowl charge port being electrically coupled to said bowl rechargeable battery for charging said bowl rechargeable battery;
a solid food tub being comprised of a fluid impermeable material wherein said solid food tub is configured to contain a solid food, said solid food tub being comprised of a thermally insulating material wherein said solid food tub is configured to inhibit thermal communication between the solid food and ambient air, said solid food tub having an exterior wall, said exterior wall having a lower portion being comprised of an opaque material wherein said lower portion is configured to inhibit light from passing through said lower portion, said exterior wall having an upper portion being comprised of a translucent material wherein said upper portion is configured to pass light through said upper portion, said exterior wall having a lip extending outwardly from an outer surface of said exterior wall, said lip extending around a full perimeter of said exterior wall, said lip being spaced downwardly from an upper edge of said exterior wall;
a solid food lid being removably attachable to said solid food tub, said solid food lid being comprised of a thermally insulating material wherein said solid food lid is configured to inhibit thermal communication between the solid food in said solid food tub and ambient air, said solid food lid having a plurality of air inlets and a plurality of air outlets wherein said plurality of air inlets and said plurality of air outlets is configured to pass air through said solid food lid, said solid food lid having an upper surface and a lower surface and a lip extending downwardly from said lower surface of said solid food lid, said lip on said solid food lid having a slot extending into an inwardly facing surface of said lip, said slot extending along a full perimeter of said lip, said solid food lid having a prominence extending upwardly from said upper surface, said lower surface resting on said upper edge of said exterior wall of said solid food tub having said lip on said exterior wall of said solid food tub being positioned in said slot in said inwardly facing surface of said lip for retaining said solid food lid on said solid food tub, said solid food lid being substantially hollow, each of said plurality of air inlets extending through said prominence and said lower surface of said solid food lid, each of said plurality of air inlets being elongated to extend along a substantial width of said solid food lid, said solid food lid having a heating coil chamber being located within said solid food lid, said heating coil chamber being in fluid communication with said plurality of plurality of air inlets, each of said plurality of air outlets being integrated into said lower surface of said solid food lid, each of said pair of air outlets being positioned on opposing sides of said heating coil chamber, each of said plurality of air outlets being elongated to extend along a substantial width of said solid food lid, each of said pair of air outlets being in fluid communication with said heating coil chamber, said solid food lid having a control housing extending upwardly from said prominence, said control housing on said solid food lid extending across a full width of said solid food lid, said control housing on said solid food lid being centrally located on said solid food lid;
a solid food heating unit being integrated into said solid food lid, said solid food heating unit being in thermal communication with said plurality of air inlets and said plurality of air outlets wherein said solid food heating unit is configured to heat the air passing through said solid food lid and into said solid food tub thereby heating the solid food contained in said solid food tub, said solid food heating unit comprising:
a solid food heating coil being positioned within said heating coil chamber, said solid food heating coil being in thermal communication with an interior of said heating coil chamber wherein said solid food heating coil is configured to heat the air passing through said plurality of air inlets and said plurality of air outlets thereby heating the solid food in said solid food tub;
a solid food processor being integrated into said control housing on said solid food lid, said solid food processor being electrically coupled to said solid food heating coil;
a solid food indicator being integrated into said control housing on said solid food lid thereby facilitating said solid food indicator to emit a visual alert when said solid food indicator is turned on, said solid food indicator being electrically coupled to said solid food processor, said solid food indicator being turned on when said solid food heating coil has been actuated for a pre-determined duration of time wherein said solid food indicator is configured to visually indicate the solid food in said solid food tub has been heated; and
a solid food power supply being integrated into said control housing on said solid food lid, said solid food power supply being electrically coupled to said solid food processor, said solid food power supply comprising:
a solid food rechargeable battery being positioned in said control housing on said solid food lid, said solid food rechargeable battery being electrically coupled to said solid food processor;
a solid food power button being movably integrated into a distal surface of said control housing on said solid food lid, said solid food power button being electrically coupled to said solid food processor, said solid food power button turning said solid food processor on and off;
a solid food temperature control button being movably integrated into said distal surface of said control housing on said solid food lid, said solid food temperature control button being electrically coupled to said solid food processor, said solid food temperature control button increasing an operational temperature of said solid food heating coil toward a maximum temperature each time said solid food temperature control button is depressed; and
a solid food charge port being recessed into said distal surface of said control housing on said solid food lid to facilitate said solid food charge port to insertably receive a charge cord, said solid food charge port being electrically coupled to said solid food rechargeable battery for charging said solid food rechargeable battery;
a container tub being comprised of a fluid impermeable material wherein said container tub is configured to contain a food product, said container tub being comprised of a thermally insulating material wherein said container tub is configured to inhibit thermal communication between the food product and ambient air, said container tub having basal wall and an outermost wall extending upwardly from said basal wall, said outermost wall having a bottom portion being comprised of an opaque material wherein said bottom portion is configured to inhibit light from passing through said bottom portion, said outermost wall having an top portion being comprised of a translucent material wherein said top portion is configured to pass light through said top portion, said outermost wall having a lip extending outwardly from an outer surface of said outermost wall, said lip on said outermost wall extending around a full perimeter of said outermost wall, said lip on said outermost wall being spaced downwardly from an upper edge of said outermost wall, said container tub having a heating coil recess extending downwardly into a topmost surface of said basal wall, said container tub having a control housing being disposed on said outermost wall of said container tub;
a container lid being removably attachable to said container tub, said container lid being comprised of a thermally insulating material wherein said container lid is configured to inhibit thermal communication between the food product in said container tub and ambient air, said container lid having a plurality of air inlets and a plurality of air outlets wherein said plurality of air inlets and said plurality of air outlets in said container lid is configured to pass air through said container lid, said container lid having an uppermost surface and a lowermost surface and a lip extending downwardly from said lowermost surface of said container lid, said lip on said container lid having a slot extending into an inwardly facing surface of said lip on said container lid, said slot associated with said container lid extending along a full perimeter of said lip on said container lid, said container lid having a prominence extending upwardly from said uppermost surface, said lowermost surface resting on said upper edge of said outermost wall of said container tub having said lip on said outermost wall of said container tub being positioned in said slot in said inwardly facing surface of said lip on said container lid for retaining said container lid on said container tub, said container lid being substantially hollow, each of said plurality of air inlets in said container lid extending through said prominence and said lowermost surface of said container lid, each of said plurality of air inlets in said container lid being elongated to extend along a substantial width of said container lid, said container lid having a heating coil chamber being located within said container lid, said heating coil chamber in said container lid being in fluid communication with said plurality of plurality of air inlets in said container lie, each of said plurality of air outlets in said container lid being integrated into said lowermost surface of said container lid, each of said pair of air outlets in said container lid being positioned on opposing sides of said heating coil chamber in said container lid, each of said plurality of air outlets in said container lid being elongated to extend along a substantial width of said container lid, each of said pair of air outlets in said container lid being in fluid communication with said heating coil chamber in said container lid, said container lid having a control housing extending upwardly from said prominence on said container lid, said control housing on said container lid extending across a full width of said container lid, said control housing on said container lid being centrally located on said container lid;
a container lid heating unit being integrated into said container lid, said container lid heating unit being in thermal communication with said plurality of air inlets in said container lid and said plurality of air outlets in said container lid wherein said container lid heating unit is configured to heat the air passing through said container lid and into said container tub thereby heating the food product contained in said container tub, said container lid heating unit comprising:
a container lid heating coil being positioned within said heating coil chamber in said container lid, said container lid heating coil being in thermal communication with an interior of said heating coil chamber in said container lid wherein said container lid heating coil is configured to heat the air passing through said plurality of air inlets in said container lid and said plurality of air outlets in said container lid thereby heating the container lid in said container tub;
a container lid processor being integrated into said control housing on said container lid, said container lid processor being electrically coupled to said container lid heating coil;
a container lid indicator being integrated into said control housing on said container lid thereby facilitating said container lid indicator to emit a visual alert when said container lid indicator is turned on, said container lid indicator being electrically coupled to said container lid processor, said container lid indicator being turned on when said container lid heating coil has been actuated for a pre-determined duration of time wherein said container lid indicator is configured to visually indicate the container lid in said container tub has been heated; and
a container lid power supply being integrated into said control housing on said container lid, said container lid power supply being electrically coupled to said container lid processor, said container lid power supply comprising:
a container lid rechargeable battery being positioned in said control housing on said container lid, said container lid rechargeable battery being electrically coupled to said container lid processor;
a container lid power button being movably integrated into a distal surface of said control housing on said container lid, said container lid power button being electrically coupled to said container lid processor, said container lid power button turning said container lid processor on and off;
a container lid temperature control button being movably integrated into said distal surface of said control housing on said container lid, said container lid temperature control button being electrically coupled to said container lid processor, said container lid temperature control button increasing an operational temperature of said container lid heating coil toward a maximum temperature each time said container lid temperature control button is depressed; and
a container lid charge port being recessed into said distal surface of said control housing on said container lid to facilitate said container lid charge port to insertably receive a charge cord, said container lid charge port being electrically coupled to said container lid rechargeable battery for charging said container lid rechargeable battery;
a plurality of food containers each being comprised of a fluid impermeable material wherein each of said plurality of food containers is configured to contain a food product, each of said plurality of food containers being positionable in said container tub for storing and transporting said plurality of food containers; and
a container tub heating unit being integrated into said container tub, said container tub heating unit being in thermal communication with an interior of said container tub to heat said food containers when said food containers are stored in said container tub, said container tub heating unit comprising:
a container tub heating plate having a lower surface and a top surface, said container tub heating plate being comprised of a thermally conductive material, said container tub heating plate being positioned over said heating coil recess in said topmost surface of said basal wall of said container tub, each of said plurality of food containers being positionable on said container tub heating plate;
a container tub heating coil being positioned in said heating coil recess, said container tub heating coil being in thermal communication with said container tub heating plate such that said container tub heating coil heats said container tub heating plate when said container tub heating coil is turned on wherein said container tub heating plate is configured to heat the food product stored in said plurality of food containers;
a container tub processor being integrated into said control housing on said outermost wall of said container tub, said container tub processor being electrically coupled to said container tub heating coil;
a container tub indicator being integrated into said control housing on said outermost wall of said container tube thereby facilitating said container tub indicator to emit a visual alert when said container tub indicator is turned on, said container tub indicator being electrically coupled to said container tub processor, said container tub indicator being turned on when said container tub heating coil has been actuated for a pre-determined duration of time wherein said container tub indicator is configured to visually indicate the liquid food in said container tub has been heated; and
a container tub power supply being integrated into said control housing on said outermost wall of said container tub, said container tub power supply being electrically coupled to said container tub processor, said container tub power supply comprising:
a container tub rechargeable battery being positioned in said control housing on said outermost wall of said container tub, said container tub rechargeable battery being electrically coupled to said container tub processor;
a container tub power button being movably integrated into a distal surface of said control housing on said outermost wall of said container tub, said container tub power button being electrically coupled to said container tub processor, said container tub power button turning said container tub processor on and off;
a container tub temperature control button being movably integrated into said distal surface of said control housing on said outermost wall of said container tub, said container tub temperature control button being electrically coupled to said container tub processor, said container tub temperature control button increasing an operational temperature of said container tub heating coil toward a maximum temperature each time said container tub temperature control button is depressed; and
a container tub charge port being recessed into said distal surface of said control housing on said outermost wall of said container tub to facilitate said container tub charge port to insertably receive a charge cord, said container tub charge port being electrically coupled to said container tub rechargeable battery for charging said container tub rechargeable battery.
